(19) United States
(12) Patent Application Publication
(10) Pub. No.: US 2012/0164497 A1
(43) Pub. Date: Jun. 28, 2012

(54) BATTERY

(75) Inventors: Takaya Saito, Tokyo (JP); Tomoyoshi Kurahashi, Tokyo (JP)

(73) Assignee: MITSUBISHI HEAVY INDUSTRIES, LTD., Tokyo (JP)

(21) Appl. No.: 13/334,886

(22) Filed: Dec. 22, 2011

(30) Foreign Application Priority Data
Dec. 27, 2010 (JP) 2010-290671

(51) Int. Cl. H01M 10/42

(52) U.S. Cl. 429/61

(57) ABSTRACT

A battery includes: a stacked electrode body in which a first electrode plate having a potential of a first polarity and a second electrode plate having a potential of a second polarity are stacked through a first separator; a battery case that stores the stacked electrode body in a hermetically sealed state and is charged to the potential of the first polarity; and a wall surface resin that is arranged between the battery case and the stacked electrode body stored in the battery case. A second temperature at which the wall surface resin is melted or shrunken is lower than a first temperature at which the first separator is melted or shrunken, and when the internal temperature of the battery case becomes equal to or higher than the second temperature, the battery case and the second electrode plate come into contact with each other or are short-circuited to each other.

### BACKGROUND OF THE INVENTION

1. Field of the Invention

The present invention relates to a battery, and more particularly, to a battery with enhanced safety.

Priority is claimed on Japanese Patent Application No. 2010-290671, filed on Dec. 27, 2010, the content of which is incorporated herein by reference.

2. Description of Related Art

Batteries may be classified into a primary battery performing discharging only or a secondary battery performing both charging and discharging. These have a configuration in which a battery case hermetically seals a stacked electrode body formed by stacking electrode plates, that is, a positive electrode plate and a negative electrode plate with a separator interposed between them, and are generally used to supply electric power for driving an electrical power load such as a motor in a battery system.

However, for example, when the battery system is of a stationary type, conductive fine powders mixed inside the battery case may cause manufacturing errors which are difficult to detect at the inspection during manufacturing. As a result, there is concern that minute electrical short-circuit (hereinafter, referred to as “minute short-circuit”) may occur between the positive electrode plate and the negative electrode plate inside the battery case. Further, for example, when the battery system is an electric vehicle, there is concern that the minute short-circuit may also occur due to the traffic accident or the like. Furthermore, the minute short-circuiting may occur due to dendrites generated by the battery material.

When the minute short-circuit occurs inside the battery case, a current, which flows to a current path of the minute short-circuiting, increases per unit area of the current path. Therefore, heat is rapidly radiated therefrom. Accordingly, the battery becomes so-called abnormal and is in an abnormal battery state. In the abnormal battery state, the electrode plate around the minute short-circuiting position may be adversely influenced due to the radiation of heat, and the electrolyte evaporates. Therefore, the internal pressure of the battery case increases. As a result, there is concern that the user of the battery system may be confronted with a danger such as injury.

Thus, in order to avoid such a danger by improving the safety of the battery, it has been reported that a separator, having a melting temperature lower than that of a separator disposed between electrode plates, is interposed between an aluminum foil connected to a positive electrode terminal and a copper foil connected to a negative electrode terminal and that the separator having a low melting temperature is melted faster than the separator disposed between the electrode plates in a case of the abnormal battery state. Therefore, the aluminum foil and the copper foil come into contact with each other to be short-circuited to each other and hence the current flow between the electrode plates is inhibited (e.g., see Japanese Patent Application, First Publication, No. 2003-243037).

However, although the battery of JP 2003-243037 as mentioned above discloses a configuration in which the aluminum foil and the copper foil are short-circuited to each other in a case of the abnormal battery state so as to improve the safety of the battery, the configuration is not sufficient in that the general discharging or charging of the battery may be adversely influenced as described below.

That is, in the battery of JP 2003-243037 as mentioned above, although the aluminum foil and the copper foil are both members which are not involved with the general discharging or charging of the battery (hereinafter, referred to as an uninvolved metallic member), there is a need to electrically connect one of them to the positive electrode plate and connect the other thereof to the negative electrode plate in order to cause the short-circuit. That is, a total of two uninvolved metallic members respectively having different polarities are needed in use. Because of the configuration that the separator having a low melting temperature is interposed between two uninvolved metallic members, when the battery of JP 2003-243037 as mentioned above comes into the market and used, a positional deviation may occur among two uninvolved metallic members and the separator due to a vibration or the like. As a result, even when the battery is not abnormal, that is, during the discharging or charging, there is concern that the aluminum foil and the copper foil may be short-circuited to each other. Likewise, the short-circuit occurring when the battery is not abnormal is not desirable from the viewpoint of the operational characteristics of the battery. As a result, the battery needs to be replaced without being used to the limit of the life span, which is also not desirable for the user from an economic viewpoint.

Thus, it is an object of the invention to provide a battery which improves the safety of the battery in a case of an abnormal battery state and solves the above-described problems caused by the insufficient configuration of the battery of JP 2003-243037 as mentioned above by using different types of separators.

### SUMMARY OF THE INVENTION

In order to attain the above-described object, according to an aspect of the invention, there is provided a battery including: a stacked electrode body in which a first electrode plate having a potential with a first polarity and a second electrode plate having a potential with a second polarity are stacked through a first separator; a battery case that stores the stacked electrode body in a hermetically sealed state and is charged to the potential of the first polarity; and a wall surface resin that is disposed between the battery case and the stacked electrode body stored in the battery case, wherein a second temperature at which the wall surface resin is melted or shrunken to cause disappearance or breakage thereof is lower than a first temperature at which the first separator is melted or shrunken to cause disappearance or breakage thereof, and wherein the battery case and the second electrode plate come into contact with each other or are electrically short-circuited to each other, when the internal temperature of the battery case becomes equal to or higher than the second temperature.

That is, because the wall surface resin, which is melted at the second temperature lower than the first temperature at which the first separator arranged between the electrode plates is melted, is arranged between the stacked electrode body and the battery case charged to the potential of the first polarity, it is possible to make the second electrode plate of the stacked electrode body and the battery case be electrically short-circuited to each other, when the internal temperature of the battery case becomes equal to or higher than the second temperature. Accordingly, it is possible to improve the safety of the battery in the abnormal battery state without using the uninvolved metallic member in JP 2003-243037 as mentioned above.

According to the battery of the aspect of the invention, it is possible to provide a battery which improves the safety of the battery in an abnormal battery state and which solves the above-described problems caused by the insufficient configuration of the battery of JP 2003-243037 as mentioned above by using plural types of separators.

### BRIEF DESCRIPTION OF THE DRAWINGS

FIG. 1A is an outline diagram illustrating a battery according to a first embodiment of the invention and is an outline diagram visibly showing the front side of the battery.

FIG. 1B is an outline diagram illustrating the battery according to the first embodiment of the invention and is an outline diagram illustrating the cross-section taken along the line A-A′ of FIG. 1A.

FIG. 2 is an outline diagram illustrating the cross-section of a battery according to a second embodiment of the invention.

FIG. 3 is an outline diagram illustrating the cross-section of a battery according to a third embodiment of the invention.

FIG. 4 is an outline diagram illustrating the cross-section of a battery according to a fourth embodiment of the invention.

FIG. 5 is an outline diagram illustrating the cross-section of a battery according to a fifth embodiment of the invention.

FIG. 6 is an outline diagram illustrating the cross-section of a battery according to a sixth embodiment of the invention.

### DETAILED DESCRIPTION OF THE INVENTION

A battery according to an embodiment of the invention has a characteristic point that a separator, having a property different from a separator arranged between electrode plates of a stacked electrode body, is arranged between a battery case which can work as a dummy electrode plate to be described later and a stacked electrode body, or between a dummy electrode plate described later and an electrode plate. Hereinafter, this will be described in detail by referring to the drawings.

Furthermore, the batteries according to the first to third embodiments have a configurational example in which a positive electrode plate is enclosed in a bag-shaped separator. And the batteries according to the fourth to sixth embodiments have a configurational example in which a negative electrode plate is enclosed in a bag-shaped separator.

Further, as the batteries of these embodiments, any battery such as a primary battery or a secondary battery may be used, but herein, a battery which can be charged and discharged, for example, a lithium ion secondary battery as a storage battery will be described as an example of the battery.

### First Embodiment

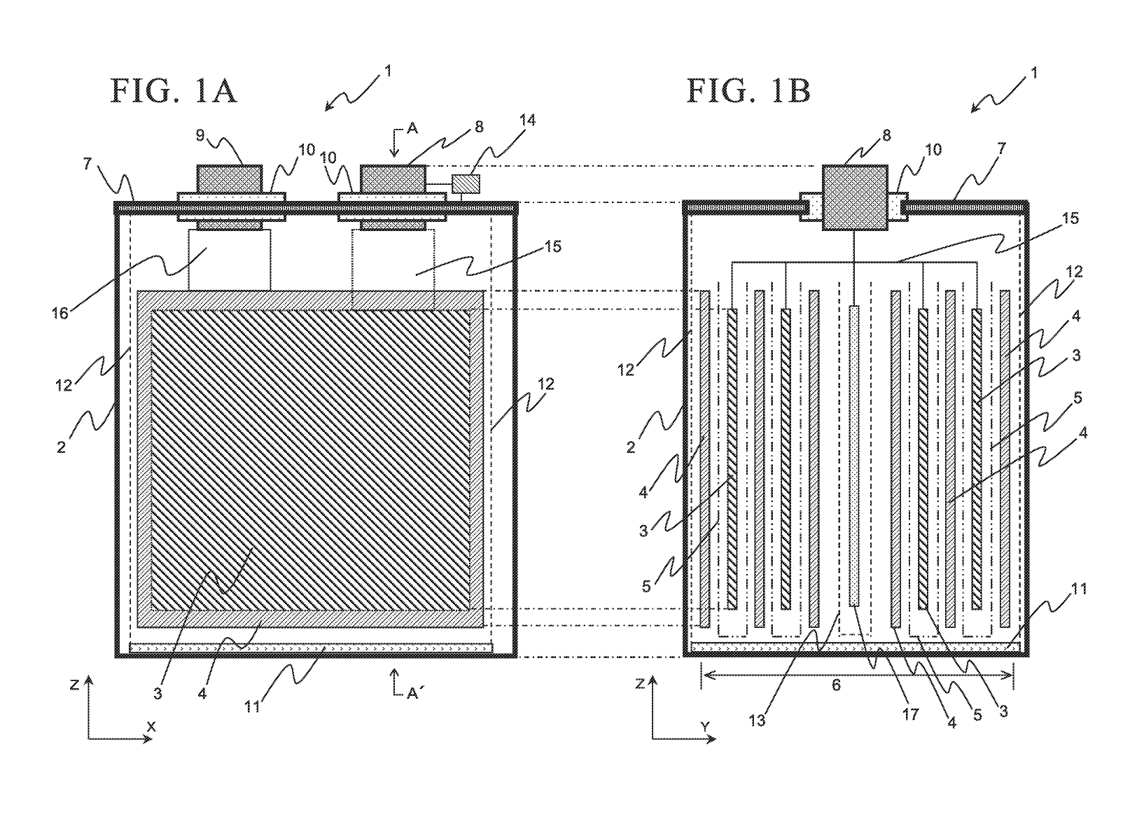

Hereinafter, a battery 1 according to the embodiment will be described by referring to FIGS. 1A and 1B. FIG. 1A is a diagram visibly illustrating the front side (the XZ plane) of the battery 1 and FIG. 1B is an outline diagram illustrating the cross-section of YZ plane with taken along the line A-A′ of FIG. 1A. Furthermore, the drawings used hereinafter all use the same orthogonal coordinate system. Because FIG. 1A is an outline diagram which promotes the understanding of the invention, the respective components shown in FIG. 1B are not all shown.

First, the battery 1 includes a container main body 2 which is formed from a square conductive material (e.g., a metal such as aluminum) and has a substantially rectangular bottom surface on the XY plane and a wall surface extending in the Z direction from all edges of the substantially rectangle, a stacked electrode body 6 which is stored in the container main body 2 and in which a positive electrode plate 3 and a negative electrode plate 4 are stacked with a separator (i.e., a first separator) 5 interposed between them, and a cover 7 which hermetically seals the container main body 2 after the stacked electrode body 6 is stored in the container main body 2 (i.e., hereinafter, a “battery case” is obtained by hermetically sealing the container main body 2 with the cover 7). Furthermore, although it is not shown in the drawings, the battery case stores an electrolyte or an electrolytic substance.

Here, the cover 7 is formed from a conductive material which is the same as that of the container main body 2. Then, the cover 7 includes electrode terminals (i.e., a positive electrode terminal 8 and a negative electrode terminal 9) having a column shape with a cross-section in the XY plane formed as a circle substantially having a diameter “r”, each of that is arranged to the position where one end protrudes outside of the battery case and the other end protrudes inside of the battery case, and an insulating resin 10 (e.g., a plastic resin or the like) which fixes the electrode terminal to the cover 7 and which electrically insulates the electrode terminal and the cover 7 from each other. As described above, because the battery case has conductivity, the stacked electrode body 6 and the battery case need to be electrically insulated from each other. For this reason, an insulating resin plate 11 (e.g., a plate or a sheet formed from a plastic resin) substantially having the same shape and sizes as those of the bottom surface is arranged on the bottom surface inside the container main body 2, and an insulating resin or insulating resins (hereinafter, referred to as a wall surface resin 12 and herein, a second separator 13 to be described later is used) substantially having the same shape and sizes as those of the wall surfaces is or are arranged on all wall surfaces inside the container main body 2.

Further, in order to prevent the degradation of the performance of the battery, a conductive portion 14 is arranged in order that the potential of the battery case is set to the positive electrode potential or the negative electrode potential of the battery 1 according to a material such as an active material of the stacked electrode body 6. Herein, because the material such as an active material of the stacked electrode body 6 has a property described below, the conductive portion 14 is connected between the positive electrode terminal 8 and the cover 7, in order that a conductive path is formed between the positive electrode terminal 8 and the battery case to maintain the battery case in the positive electrode potential. Although the conductive portion 14 may be formed as a wiring which has a low electrical resistance in order that a heat radiation performance improves, a resistor which has a high resistance (e.g., 10 MΩ) is used in consideration of the safety.

As an example, the stacked electrode body 6 is an electrode body which is a stacked-type. That is, there are a plurality of positive electrode plates 3, negative electrode plates 4, and the first separators 5, and the positive electrode plate 3 is sequentially put on the negative electrode plate 4 through the first separator 5 interposed between them.

Each positive electrode plate 3 is formed by coating a positive electrode active material such as lithium magnate on both surfaces of a positive electrode metallic foil such as aluminum, and by punching the coated positive electrode metallic foil in a substantially rectangular shape. At the time, a section of the positive electrode metallic foil, which is not coated by the positive electrode active material, is punched together with the positive electrode plate 3, and the section of the positive electrode metallic foil punched out becomes a positive electrode tab 15 which is connected to the positive electrode plate 3.

On the other hand, each negative electrode plate 4 is formed by coating a negative electrode active material such as carbon on both surfaces of a negative electrode metallic foil such as copper, and by punching the coated negative electrode metallic foil in a substantially rectangular shape. At the time, a section of the negative electrode metallic foil which is not coated by the negative electrode active material is punched together with the negative electrode plate 4, and the section of negative electrode metallic foil punched out becomes a negative electrode tab 16 which is connected to the negative electrode plate 4. The size of the substantially rectangular shape in the XZ plane of the negative electrode plate 4 is a size in which the negative electrode plate can be stored inside the battery case without being bent. The size of the substantially rectangular shape in the XZ plane of the positive electrode plate 3 is smaller than the size of the substantially rectangular shape in the XZ plane of the negative electrode plate 4. Accordingly, as shown in FIG. 1A, the positive electrode plate 3 is arranged within the plane of the negative electrode plate 4, when it is seen from the Y direction. Further, the negative electrode tab 16 is arranged at a position in which it does not overlap the positive electrode tab 15 on the XZ plane, when the positive electrode plate 3 and the negative electrode plate 4 are stacked in the Y direction as described below.

The first separator 5 may be a separator which is formed from a resin or ceramic. That is, for the first separator 5; any separator is applicable to the battery, when the relation in property to the second separator 13 is satisfied. Herein, the first separator 5 is formed in a bag shape, and the sizes of the bag are designed in order that the entire surfaces of the positive electrode plate 3 can be received inside the bag and that the positive electrode tab 15 can protrude from the bag.

In this specification, to “enclose” is defined as to store the electrode plate (i.e., the positive electrode plate 3 or the negative electrode plate 4) or the dummy electrode plate (i.e., the dummy electrode plates 17 or 17a to be described later) inside the bag-shaped separator and to protrude the electrode tab (i.e., the positive electrode tab 15, the negative electrode tab 16, or the dummy electrode tab) from the inside of the bag-shaped separator to the outside.

One of the negative electrode plates 4 that have sizes larger than those of the positive, electrode plates 3 starts to be stacked. One of the positive electrode plate 3 enclosed by the bag-shaped first separator 5 is stacked on the one of the negative electrode plate 4 (to the +Y direction), and then another of the negative electrode plates 4 is stacked on the one of the positive electrode plate 3 enclosed by the first separator 5 (to the +Y direction). At this time, the negative electrode plates 4 are stacked in order that the negative electrode tabs 16 are arranged at the same position in the XZ plane.

And this procedure is sequentially repeated. As a result, a stacked electrode body 6 is formed which includes plural positive electrode plates 3 and plural negative electrode plates 4 and in which the negative electrode plates 4 are arranged at both ends in the Y direction when seen from the X direction.

Furthermore, all positive electrode tabs 15 which are evenly arranged at substantially the same position when seen from the Y direction are electrically connected to the positive electrode terminal 8 by riveting, welding, or the like. At this time, the positive electrode tab 15 may be directly connected to the positive electrode terminal 8. A metallic positive electrode lead may be interposed between the positive electrode tab 15 and the positive electrode terminal 8. Further, all negative electrode tabs 16 which are evenly arranged at substantially the same position when seen from the Y direction are electrically connected to the negative electrode terminal 9 by riveting, welding, or the like. At this time, the negative electrode tab 16 may be directly connected to the negative electrode terminal 9. A metallic negative electrode lead may be interposed between the negative electrode tab 16 and the negative electrode terminal 9.

Here, the materials of the first separator 5 and the second separator 13 are respectively selected in order that the second separator 13 is melted or shrunken to cause disappearance or breakage thereof at a second temperature which is lower than a first temperature at which the first separator 5 is melted or shrunken to cause disappearance or breakage thereof, when the internal temperature of the battery case increases because the minute short-circuiting occurs. Of course, the internal temperature of the battery case may increase to a certain extent during the discharging or charging in the battery 1. Therefore, there is a need to set the second temperature to be higher than the temperature increased to the certain extent (hereinafter, referred to as a third temperature).

For example, when the first separator 5 and the second separator 13 are resinous separators which are formed from the same material, the thickness of the second separator 13 in the Y direction may be designed to be thinner than (e.g., about a half of) the thickness of the first separator 5 in the Y direction. In this case, as the materials of the first separator 5 and the second separator 13, the same material may be used in a resin such as polypropylene or polyethylene. The third temperature is dependent on the environment where the battery 1 is located, but may be substantially considered to be approximately equal to or higher than 40° C. and equal to or lower than 50° C. Therefore, in this case, the polyethylene may be a low-density polyethylene having a melting point of about 80° C.

Further, when the first separator 5 and the second separator 13 are formed from different materials, it is desirable that the second separator 13 be formed as a resinous separator and be formed from a material having a melting point lower than that of the first separator 5. In this case, for example, the material of the first separator 5 may be polypropylene having a melting point of about 160° C., and the material of the second separator 13 may be low-density polyethylene or high-density polyethylene having a melting point of about 140° C.

With the above-described configuration, when the minute short-circuit occurs in the battery 1 and that the internal temperature of the battery case continuously increases abruptly, the second separator 13 which is used as the wall surface resin 12 is melted faster than the first separator 5, and a part or most of the wall surface resin 12 which is interposed between the battery case and the negative electrode plates 4 arranged at both ends of the stacked electrode body 6 in the Y direction disappears. As a result, the negative electrode plate 4 directly comes into contact with the battery case which is maintained at the positive electrode potential by the “plane” of them. Accordingly, electrical short-circuiting occurs between the battery case and the negative electrode plate 4. It means that the positive electrode plate 3 and the negative electrode plate 4 are short-circuited to each other. However, because the short-circuiting between the battery case and the negative electrode plate 4 is not started by the “point” contact between the battery case and the negative electrode plate 4 but by the “plane” contact between them, the electrical resistance at the electrical path of the short-circuiting is low. Accordingly, because the current flows to the position of the short-circuiting at the “plane” contact instead of the position of the minute short-circuiting having a high electrical resistance immediately after the short-circuiting occurs, it is possible to prevent the position of the minute short-circuiting from generating heat.

Moreover, as described above, because the positive electrode plate 3 and the negative electrode plate 4 are short-circuited to each other, the function of the battery is lost after a predetermined time elapses from the short-circuiting at the “plane”. That is, the function of the battery is automatically stopped before a user is confronted with a danger such as an injury. Therefore, it is possible to improve the safety of the battery.

That is, it is possible to improve the safety without using the uninvolved metallic member mentioned in JP 2003-243037 as mentioned above. Further, because the wall surface resin 12 substantially has the same shape and sizes as those of the wall surface, the size thereof is considerably larger than the size in the XZ plane of the negative electrode plate 4. Accordingly, it is possible to solve the problem resulting from the above-described positional deviation in the structure disclosed in JP 2003-243037 as mentioned above.

Furthermore, in FIG. 1B, a configuration is also shown in which the dummy electrode plate 17 inserted and enclosed inside the second separator 13 formed in a bag shape is inserted into the stacked body 6 in addition to the above-described configuration.

The dummy electrode plate 17 may be formed, for example, by punching a positive electrode metallic foil, on which a positive electrode active material is not covered, in the punching device that punches the above-described positive electrode plate 3. In this case, the sizes and the shape of the dummy electrode plate 17, formed from the positive electrode metallic foil, are the same as the size and the shape in the XZ plane of the positive electrode plate 3 in addition to the positive electrode tab 15 connected thereto. Accordingly, the dummy electrode plate 17 also has a shape corresponding to the positive electrode tab 15 (hereinafter, referred to as a dummy electrode tab).

Then, the dummy electrode plate 17 is received in the bag-shaped second separator 13, and the dummy electrode tab protrudes outward from the inside of the bag of the bag-shaped second separator 13 which is formed in the same manner as the bag-shaped first separator 5. The dummy electrode plate 17 is enclosed by the bag-shaped second separator 13. And one of the positive electrode plates 3 that are enclosed by the bag-shaped first separator 5 and that are stacked inside the stacked electrode body 6, is switched to the dummy electrode plate 17. In particular, the dummy electrode plate 17 is arranged near the middle of the stacked electrode body, where is the same location as the one of the positive electrode plates 3. Therefore, all of the positive electrode tabs 15 and the dummy electrode tab are stacked and made all of uniform location. Further, these tabs are connected to the positive electrode terminal 8 as in the above-described case. Therefore, the dummy electrode plate 17 has a positive electrode potential.

For this reason, when the internal temperature of the battery case continuously increases abruptly due to the minute short-circuiting with respect to the battery 1, the second separator 13 which encloses the dummy electrode plate 17 is melted faster than the first separator 5 in the vicinity of the middle of the stacked electrode body 6. And two negative electrode plates 4, that exist respectively at both ends of the dummy electrode plate 17 in the Y direction, directly comes into contact on the “plane” with the dummy electrode plate 17 having the positive electrode potential. Accordingly, because the short-circuit on the “plane” occurs in the dummy electrode plate 17 in addition to the short-circuit on the “plane” occurring in the above-described battery case, the function of the battery becomes to be lost faster. That is, it is possible to shorten the predetermined time. Accordingly, the safety of the battery becomes further improved. Furthermore, in this case, one dummy electrode plate 17 corresponding to the uninvolved metallic member mentioned in JP 2003-243037 as mentioned above is used. However, because the dummy electrode plate 17 is enclosed by the bag-shaped second separator 13, it is possible to solve the problem resulting from the above-described positional deviation in the structure of JP 2003-243037 as mentioned above.

In the above-described battery 1, the second separator 13 is directly used as the wall surface resin 12, but the wall surface resin 12 does not need to have the function of the separator because only the material of the second separator 13 needs to be used. Accordingly, the wall surface of the container main body 2 may be coated with the above-described material, for example, a resin such as polyethylene. In this case, the above-described positional deviation in the structure of JP 2003-243037 as mentioned above cannot occur. Therefore, the above-described problem may be more satisfactorily solved.

### Second Embodiment

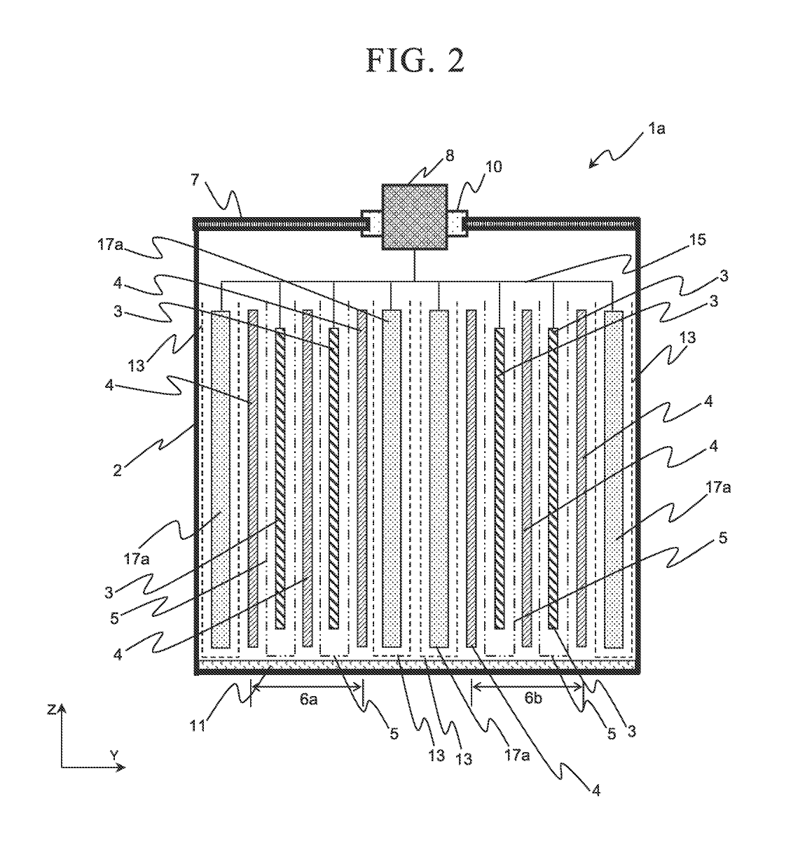

Next, a battery 1a of a second embodiment will be described by referring to FIG. 2. The battery case of the battery 1a has the same shape as that of the battery case of the battery 1, and the outline diagram visibly showing the front side of the battery 1a (in the XZ plane) will be omitted because it is the same as that of FIG. 1A. FIG. 2 is an outline diagram illustrating the cross-section in the YZ plane and corresponding to FIG. 1B of the battery 1. Further, in FIG. 2, the same components as those of FIG. 1 will have the same reference numerals applied thereto, and a description thereof will not be repeated here.

One of differences between the battery 1a of the second embodiment and the battery 1 of the first embodiment is as below. Each of plural stacked electrode bodies (where those are respectively described as 6a and 6b because two stacked electrode bodies are used), having the same structure as that of the stacked electrode body 6 in the Y direction, is sandwiched by two dummy electrode plates 17a (which is enclosed by the bag-shaped second separator 13 as in the dummy electrode plate 17 shown in the first embodiment). The dummy electrode plates 17a is formed to be approximately equal to or larger than the size and the shape of the negative electrode plate 4 and the negative electrode tab 16 connected thereto in the XZ plane, and to be thick (i.e., the size in the Y direction) and rigid.

In other words, in the battery 1a of the second embodiment which is different from the battery 1 of the first embodiment, the number of the dummy electrode plates 17a arranged in one stacked electrode body is two. Further, the size of the dummy electrode plate 17a in the XZ plane is not a size of the positive electrode plate 3 and the positive electrode tab 15, and the size is approximately equal to or larger than a size of the negative electrode plate 4 and the negative electrode tab 16. It means that there is a dummy electrode tab in the dummy electrode plate 17a, which has the same shape as that of the negative electrode tab 16 and that the dummy electrode tab is tied to the positive electrode tab 15 in order to be connected to the positive electrode terminal 8, as described below.

Furthermore, the thickness in the Y direction of the dummy electrode plate 17a is thicker than the thickness of the positive electrode plate 3 or the negative electrode plate 4 in order to have rigidity against bending as a single body, which is, for example, a thickness of about 1 mm. As to the dummy electrode plate 17 of the battery 1, the dummy electrode plate 17a is received inside the bag of the bag-shaped second separator 13 and the dummy electrode tab protrudes outward from the bag.

Here, when the oxidation-reduction potential of the dummy electrode plate 17a is not included in the range of the potential which is applied to the dummy electrode plate 17a (however, it does not include a case that a film of a passivation or the like is formed on the surface of the dummy electrode plate 17a and that the dummy electrode plate 17a is not ionized) and that the range of the potential is not a potential in which the dummy electrode plate 17a does not absorb ions for exhibiting the function of the battery (e.g., the lithium ion in a case of the lithium ion secondary battery), the material of the dummy electrode plate 17a may be a conductive material which has a low electrical resistance. Accordingly, when the dummy electrode plate 17a is electrically connected to the positive electrode plate 3 as described above, the dummy electrode plate 17a may be formed by the metal of the positive electrode metallic foil. Further, when the dummy electrode plate 17a is electrically connected to the negative electrode plate 4 as described below, the dummy electrode plate 17a may be formed by the metal of the negative electrode metallic foil.

Then, between two of the negative electrode plates 4 at both ends of the stacked electrode body 6 (i.e., 6a and 6b) in the Y direction, one dummy electrode plate 17a enclosed by the bag-shaped second separator 13 is arranged at the −Y side of the two of the negative electrode plate 4, and the other dummy electrode plate 17a enclosed by the bag-shaped second separator 13 is arranged at the +Y side of the two of the negative electrode plate 4. Therefore, the stacked electrode body 6 is interposed between the two dummy electrode plates 17a and all of the positive electrode plates 3 and the negative electrode plates 4 are included in the plane of the dummy electrode plate 17a in the XZ plane. Then, the two dummy electrode plates 17a are reliably connected to each other by an insulation tape (not shown). Therefore, the stacked electrode body 6 is fixed between the two dummy electrode plates 17a, while the positive electrode, plate 3 is maintained to be arranged within the plane of the negative electrode plate 4 as described above. At this time, the dummy electrode tab of the dummy electrode plate 17a overlaps the positive electrode tab 15 when seen from the Y direction, and the dummy electrode tab is arranged so as not to contact the negative electrode tab 16. Accordingly, all of the positive electrode tabs 15 and the dummy electrode tabs are stacked while being evenly arranged. Further, these tabs are connected to the positive electrode terminal 8 similarly to the battery 1 of the first embodiment. Therefore, the dummy electrode plate 17a has a positive electrode potential.

Furthermore, because the dummy electrode plates 17a disposed at both ends of the stacked electrode body 6 in the Y direction are enclosed by the bag-shaped second separators 13, the battery 1a of the second embodiment does not need to be separately equipped with the wall surface resin 12 provided in the battery 1 of the first embodiment. That is, the second separator 13 serves as the wall surface resin 12.

With this configuration, as in the battery 1 of the first embodiment, when the internal temperature of the battery case continuously increases abruptly due to the minute short-circuit, the second separator 13 which encloses the dummy electrode plate 17a is melted faster than the first separator 5, and two negative electrode plates 4 present at both ends of the stacked electrode body 6 in the Y direction directly come into contact on the “plane” with the dummy electrode plate 17a having a positive electrode potential. Accordingly, it is possible to improve the safety of the battery. Furthermore, when the second separator 13 is melted or the like, the dummy electrode plate 17a comes into contact with the battery case, but the safety improvement is not particularly influenced because they have the potential of the same polarity.

Further, the dummy electrode plate 17a works as an insertion guide when the stacked electrode body 6 is inserted into the container main body 2, and protects the stacked electrode body 6. Therefore, the positive electrode plate 3 or the negative electrode plate 4 is able to be prevented from being bent. Accordingly, because the failure of the battery is able to be further prevented, not only the safety of the battery but also the performance of the battery is able to be further improved.

Furthermore, when the dummy electrode plate 17a comes into contact on the “plane” as described above, small through-holes passing through the dummy electrode plate 17a in the Y direction may be formed in order to satisfactorily circulate the electrolyte. According to this configuration, because the electrolyte is able to be effectively circulated, the performance of the battery is able to be further improved.

### Third Embodiment

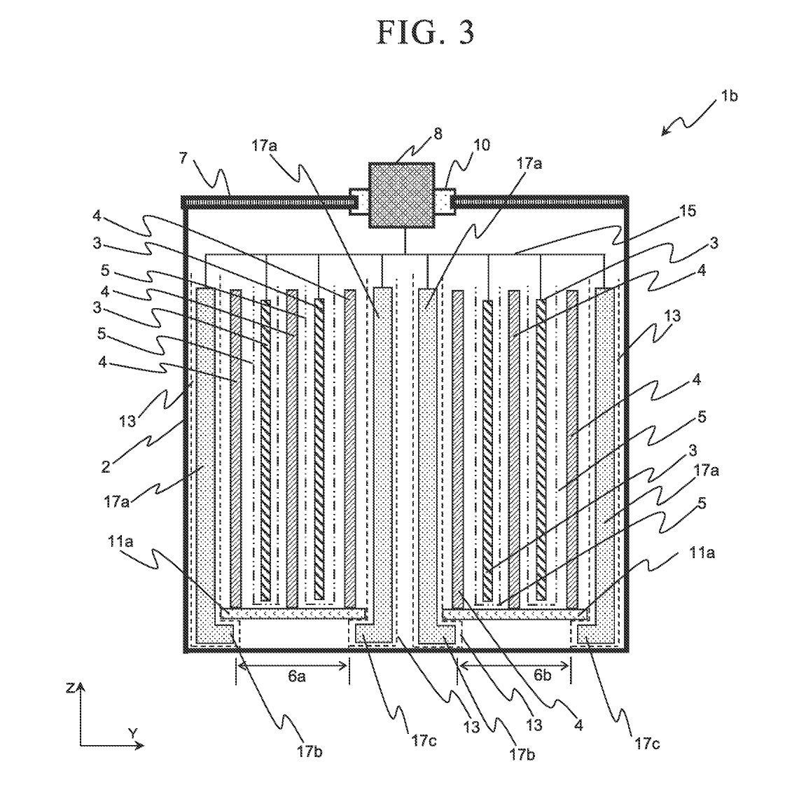

Next, a battery 1b of the third embodiment will be described by referring to FIG. 3. The battery case of the battery 1b has the same shape as that of the battery case of the battery 1a, and the outline diagram visibly showing the front side of the battery 1b (in the XZ plane) will be omitted because it is the same as that of FIG. 1A. FIG. 3 is an outline diagram illustrating the cross-section in the YZ plane and corresponding to FIG. 1B of the battery 1. Further, in FIG. 3, the same components as those of FIG. 2 showing the battery 1a of the second embodiment will have the same reference numerals applied thereto, and a description thereof will not be repeated here.

One of differences between the battery 1b of the third embodiment and the battery 1a of the second embodiment is as below. In the battery 1a, because the shape and the sizes of the insulating resin plate 11 are substantially the same as the shape and the size of the bottom surface of the battery case, only one resin plate 11, which is commonly used in plural stacked electrode bodies 6a and 6b, is provided. However, in the battery 1b, each stacked electrode body is provided with one insulating resin plate 11a, of which the size is approximately equal to the size of the stacked electrode body 6 in the XY plane. Then, the resin plate 11a corresponding to one of the stacked electrode body 6 is held by the dummy electrode plate 17a and hook portions (i.e., 17b and 17c) of the dummy electrode plate 17a. The hook portion 17b is formed at the −Z-side end in the Z-direction ends of the one dummy electrode plates 17a, and the hook portion 17c is formed at the −Z-side end in the Z-direction ends of the other dummy electrode plates 17a.

The hook portion 17b is electrically connected to the −Z-side end of the one dummy electrode plate 17a, and the hook portion 17c is electrically connected to the −Z-side end of the other dummy electrode plate 17a. In this description, each of the hook portion 17b and the hook portion 17c is directly or indirectly physically connected to the corresponding dummy electrode plate 17a in order to form and to maintain the hook shape to be described later.

In FIG. 3, the plane of the dummy electrode plate 17a in the XY plane is designed and formed to be slightly long in the Z direction, and one end of the long portion of the dummy electrode plate 17a is bent to the Y direction to form the hook portion 17b or the hook portion 17c. The portion bent to the +Y direction works as the hook portion 17b, and the portion bent to the −Y direction works as the hook portion 17c. The hook portions are formed to be about 90° with respect to the XZ plane of the dummy electrode plate 17a when seen from the YZ plane. The manufacturing may be more easily performed when the bending is performed after the dummy electrode plate 17a is enclosed in the bag-shaped second separator 13.

Furthermore, in FIG. 3, an example is shown in which the hook portion 17b and the hook portion 17c are formed by bending a part of the dummy electrode plates 17a, but may be formed from metal separated from the dummy electrode plate 17a by welding or the like.

Then, as in the battery 1a of the second embodiment, the stacked electrode body 6 is interposed between the one dummy electrode plate 17a having the hook portion 17b and the other dummy electrode plate 17a having the hook portion 17c. The stacked electrode body 6 and the resin plate 11a are supported by the hook portion 17b and the hook portion 17c, the two dummy electrode plates 17a are reliably connected to each other by an insulation tape (not shown) as in the battery 1a of the second embodiment, and the stacked electrode body 6 is fixed between the two dummy electrode plates 17a. Further, as in the battery 1a of the second embodiment, all of the positive electrode tabs 15 and the dummy electrode tabs are connected to the positive electrode terminal 8. Therefore, the dummy electrode plates 17a have a positive electrode potential.

With this configuration, when the internal temperature of the battery case continuously increases abruptly due to the minute short-circuit as in the battery 1a of the second embodiment, the second separator 13 which encloses the dummy electrode plate 17a is melted faster than the first separator 5, and two negative electrode plates 4 present at both ends of the stacked electrode body 6 in the Y direction come into directly contact on the “plane” with the dummy electrode plate 17a having a positive electrode potential. Accordingly, it is possible to improve the safety of the battery. Furthermore, when the second separator 13 is melted, the dummy electrode plate 17a comes into contact with the battery case, but the safety improvement is not particularly influenced because they have the potential of the same polarity.

Further, the dummy electrode plate 17a works as an insertion guide when the stacked electrode body 6 is inserted into the container main body 2, and protects the stacked electrode body 6. Therefore, the positive electrode plate 3 or the negative electrode plate 4 is able to be prevented from being bent. In particular, in the embodiment, because the hook portion 17b or the hook portion 17c, which has a large size in the Y direction compared to the second embodiment, comes into contact with the wall surface of the container main body 2 during the insertion, the function as the insertion guide is further reinforced. Accordingly, it is possible to more strongly prevent the positive electrode plate 3 or the negative electrode plate 4 from being bent compared to the battery 1a of the second embodiment. Accordingly, because the failure of the battery is able to be further prevented, not only the safety of the battery but also the performance of the battery is able to be further improved.

In a case that small through-holes passing through the resin plate 11a in the Z direction are provided in addition to the above-described small through holes passing through the dummy electrode plate 17a in the second embodiment, because the electrolyte is able to be more effectively circulated, the performance of the battery is able to be further improved compared to the above-described battery 1a in the second embodiment.

Furthermore, the temperature of the vicinity of the middle of the battery case may be higher than the temperature of the wall surface of the battery case during the minute short-circuiting. However, at this time, the dummy electrode plate 17a which is interposed between the plural stacked electrode bodies 6 (e.g., herein two dummy electrode plates 17a are interposed between the stacked electrode body 6a and the stacked electrode body 6b) comes into contact with the battery case, and the heat in the vicinity of the middle is able to be radiated to the outside of the battery case, because the second separator 13 is melted and because the hook portion 17b and the hook portion 17c come into contact with the battery case. Because these hook portions are pressed against the battery case to the −Z direction by the weight of the stacked electrode body 6, the radiation of heat is able to be more reliably and effectively performed. Accordingly, the safety of the battery is able to be further improved.

### Fourth Embodiment

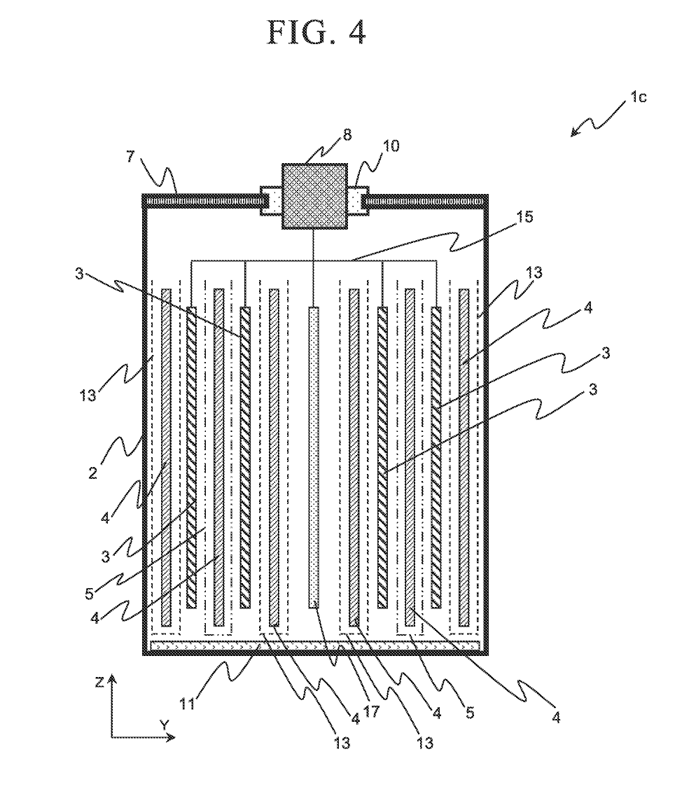

Next, a battery 1c of the fourth embodiment will be described by referring to FIG. 4. The battery case of the battery 1c has the same shape as that of the battery case of the battery 1, and the outline diagram visibly showing the front side of the battery 1c in the XZ plane will be omitted because it is the same as that of FIG. 1A. FIG. 4 is an outline diagram illustrating the cross-section in the YZ plane and corresponding to FIG. 1B of the battery 1. Further, in FIG. 4, the same components as those of FIG. 1 will have the same reference numerals applied thereto, and a description thereof will not be repeated here.

One of differences between the battery 1c of the fourth embodiment and the battery 1 of the first embodiment is as mentioned below. In the battery 1, the positive electrode plate 3 is enclosed in the bag-shaped first separator 5. However, in the battery 1c, the negative electrode plate 4 is enclosed in the bag-shaped first separator 5 instead of the positive electrode plate 3. In the battery 1c, the two of the negative electrode plates 4, which are arranged at both ends of the stacked electrode body 6 in the Y direction, are enclosed in the corresponding bag-shaped second separator 13, because the positive electrode plate 3 is not enclosed by the bag-shaped separator. That is, the second separator 13 is formed in a bag shape, the entire surfaces of the negative electrode plate 4 are received inside the bag, and the negative electrode plate 4 is disposed inside the bag. The negative electrode tab 16 protrudes outward from the bag. For this reason, because the second separator 13 works as the wall surface resin 12, the battery 1c does not need to have the wall surface resin 12 arranged in the battery 1.

Furthermore, as in the battery 1, one of the positive electrode plates 3 in the stacked electrode body 6 is switched to the dummy electrode plate 17. Particularly the positive electrode plate 3 in the vicinity of the middle of the stacked electrode body 6 is switched, and the dummy electrode plate 17 is arranged at the same position as that of the positive electrode plate 3. As mentioned above, in the battery 1, the dummy electrode plate 17 is enclosed in the bag-shaped second separator 13. However, in the battery 1c, the dummy electrode plate 17 is not enclosed in the bag-shaped separator. Therefore, in the battery 1c, two negative electrode plates 4, which are very close to the dummy electrode plate 17, are enclosed not in the bag-shaped first separator 5 but in the bag-shaped second separator 13.

Furthermore, even in the battery 1c as in the battery 1, all of the positive electrode tabs 15 and the dummy electrode tabs are stacked and are connected to the positive electrode terminal 8. Therefore, the dummy electrode plate 17 has a positive electrode potential.

With this configuration, when the internal temperature of the battery case continuously increases abruptly due to the minute short-circuit as in the battery 1 of the first embodiment, the second separator 13 enclosing the negative electrode plate 4 is melted faster than the first separator 5, and two negative electrode plates 4 at both ends of the stacked electrode body 6 in the Y direction come into contact on the “plane” with the battery case having a positive electrode potential. Accordingly, it is possible to improve the safety of the battery.

When the second separator 13 is melted, two negative electrode plates 4 at both ends respectively come into contact with the positive electrode plates 3. At this time, because the contact with the battery case has a low electrical resistance compared to the contact with the positive electrode plate 3, a current intensively flows to the contact with the battery case. Accordingly, the influence of heat radiated from the contact between the positive electrode plate 3 and the negative electrode plate 4 is small, and the safety improvement is not particularly influenced.

Further, when that the internal temperature of the battery case continuously increases abruptly due to the minute short-circuit as in the battery 1 of the first embodiment, even in the vicinity of the middle of the stacked electrode body 6, the second separator 13 which encloses the negative electrode plate 4 is melted faster than the first separator 5, and two negative electrode plates 4 at both ends of the dummy electrode plate 17 in the Y direction directly come into contact on the “plane” with the dummy electrode plate 17 having a positive electrode potential. Accordingly, because the short-circuit on the “plane” occurs in the dummy electrode plate 17 in addition to the above-described short-circuiting on the “plane” occurring in the battery case, the function of the battery is able to be lost faster. That is, it is possible to shorten the predetermined time. Accordingly, the safety of the battery is able to be further improved.

### Fifth Embodiment

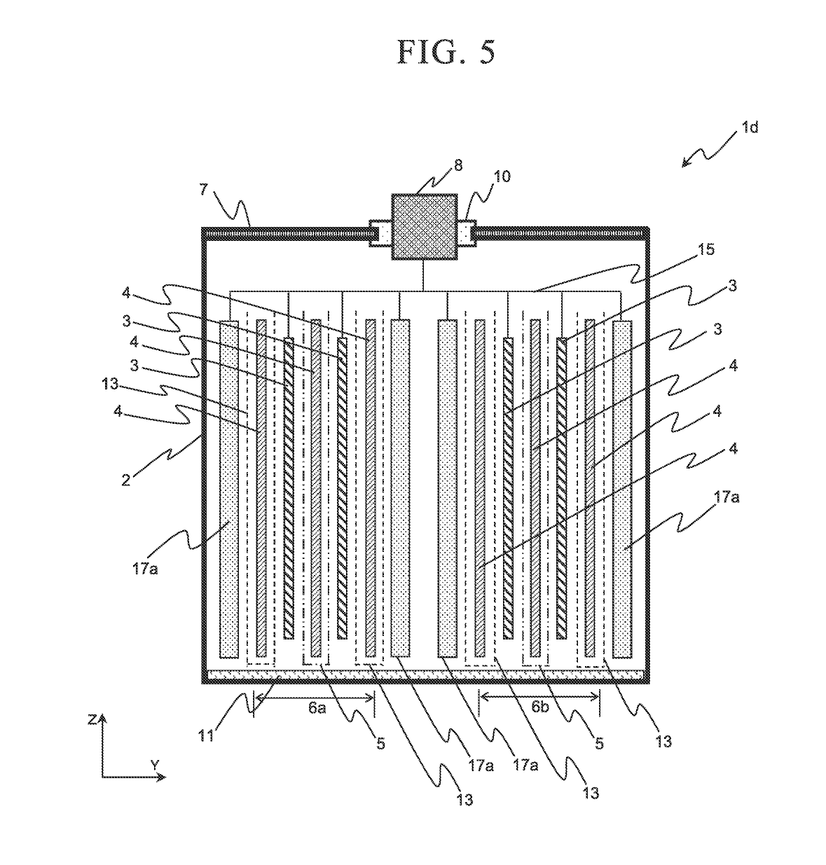

Next, a battery 1d of the fifth embodiment will be described by referring to FIG. 5. The battery case of the battery 1d has the same shape as that of the battery case of the battery 1, and the outline diagram visibly showing the front side of the battery 1d in the XZ plane will be omitted because it is the same as that of FIG. 1A. FIG. 5 is an outline diagram illustrating the cross-section in the YZ plane and corresponding to FIG. 1B of the battery 1. Further, in FIG. 5, the same components as those of FIG. 2 showing the battery 1a of the second embodiment will have the same reference numerals applied thereto, and a description thereof will not be repeated here.

One of differences between the battery 1d of the fifth embodiment and the battery 1a of the second embodiment is as below. In the battery 1a, the positive electrode plate 3 is enclosed in the bag-shaped first separator 5. However, in the battery 1d, the negative electrode plate 4 is enclosed in the bag-shaped first separator 5 instead of the positive electrode plate 3. Further, in the battery 1d, the negative electrode plates 4 at both ends of each of the stacked electrode bodies 6 (i.e., the stacked electrode bodies 6a and 6b) in the Y direction are enclosed in the bag-shaped second separator 13. The positive electrode plate 3 is not enclosed in the bag-shaped separator.

Furthermore, in the battery 1a, the dummy electrode plate 17a is enclosed in the bag-shaped-second separator 13. However, in the battery 1d, the dummy electrode plate 17a is not enclosed in the bag-shaped separator. In the battery 1d, the wall surface resin 12, which is provided in the battery 1 of the first embodiment, is not provided. Accordingly, among the dummy electrode plates 17a, two of the dummy electrode plates 17a that are very close to the battery case, directly come into contact on the “plane” with the battery case. Here, the second separator 13, which encloses the negative electrode plate 4 arranged at both ends of each of the stacked electrode bodies 6 (i.e., the stacked electrode bodies 6a and 6b) in the Y direction works as the wall surface resin 12.

Furthermore, there is the following similarity between the battery 1d and the battery 1a. That is, one dummy electrode plate 17a is arranged at the −Y side of the negative electrode plate 4 which is located at the −Y side among the negative electrode plates 4 enclosed by the bag-shaped second separators 13 in one of the stacked electrode bodies 6, another dummy electrode plate 17a is arranged at the +Y side of the negative electrode plate 4 which is located at the +Y side among the negative electrode plates 4 enclosed by the bag-shaped second separators 13 in one of the stacked electrode bodies 6. The stacked electrode body 6 is interposed between the two dummy electrode plates 17a. And all of the positive electrode plates 3 and the negative electrode plates 4 are included in the plane of the dummy electrode plate 17a in the XZ plane. Then, the two dummy electrode plates 17a are reliably connected to each other by an insulation tape (not shown). Therefore, the stacked electrode body 6 is fixed between the two dummy electrode plates 17a, while the positive electrode plate 3 is maintained to be arranged within the plane of the negative electrode plate 4 as described above. At this time, the dummy electrode tab of the dummy electrode plate 17a overlaps the positive electrode tab 15 when seen from the Y direction. All of the positive electrode tabs 15 and the dummy electrode tabs are stacked and are evenly arranged. Therefore, the dummy electrode tab does not contact with the negative electrode tab 16. Further, these tabs are connected to the positive electrode terminal 8. Therefore, the dummy electrode plate 17a has a positive electrode potential.

According to this configuration, when the internal temperature of the battery case continuously increases abruptly due to the minute short-circuit as in the battery 1a of the second embodiment, the second separator 13 which encloses the negative electrode plate 4 is melted faster than the first separator 5, and the negative electrode plate 4 directly comes into contact on the “plane” with the dummy electrode plate 17a having a positive electrode potential. Accordingly, it is possible to improve the safety of the battery.

Further, the dummy electrode plate 17a serves as an insertion guide when the stacked electrode body 6 is inserted into the container main body 2, and protects the stacked electrode body 6. Therefore, the positive electrode plate 3 or the negative electrode plate 4 is able to be prevented from being bent. Accordingly, because the failure of the battery is able to be further prevented, not only the safety of the battery but also the performance of the battery is able to be further improved.

Furthermore, as described above, because the dummy electrode plate 17a which is very close to the battery case directly comes into contact on the “plane” with the battery case, the battery case has a positive electrode potential. Therefore, the conductive portion 14, which is arranged at each of the batteries described in the first to the fourth embodiments, does not needed. That is, because the number of components is able to be reduced with compared to the batteries described in the first to the fourth embodiments, the manufacturing cost is able to be reduced. In a case that the effect is not considered, the dummy electrode plate 17a may be enclosed in the bag-shaped second separator 13 as in the battery 1a of the second embodiment. In this case, the second separator 13 also works as the wall surface resin 12.

### Sixth Embodiment

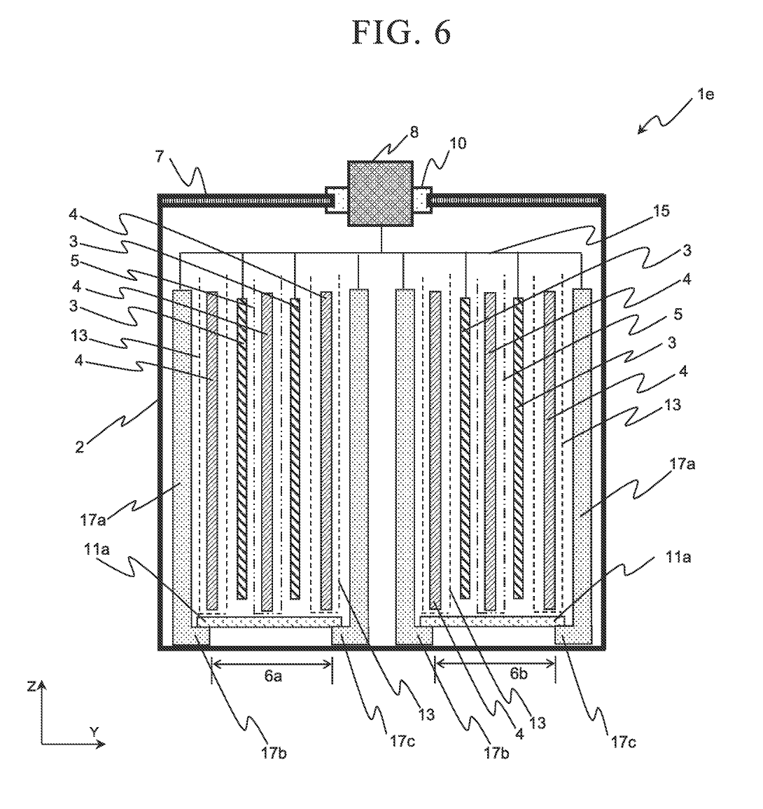

Next, a battery 1e of the sixth embodiment will be described by referring to FIG. 6. The battery case of the battery 1e has the same shape as that of the battery case of the battery 1, and the outline diagram visibly showing the front side of the battery 1e in the XZ plane will be omitted because it is the same as that of FIG. 1A. FIG. 6 is an outline diagram illustrating the cross-section in the YZ plane and corresponding to FIG. 1B of the battery 1. Further, in FIG. 6, the same components as those of FIG. 3 showing the battery 1b of the third embodiment will have the same reference numerals applied thereto, and a description thereof will not be repeated here.

One of differences between the battery 1e of the sixth embodiment and the battery 1b of the third embodiment is as below. In the battery 1b, the positive electrode plate 3 is enclosed in the bag-shaped first separator 5. However, in the battery 1e, the negative electrode plate 4 is enclosed in the bag-shaped first separator 5 instead of the positive electrode plate 3. Further, in the battery 1e, two of the negative electrode plates 4, which are arranged at both ends of each of the stacked electrode bodies 6 (i.e., the stacked electrode bodies 6a and 6b) in the Y direction, are enclosed in the bag-shaped second separators 13. The positive electrode plate 3 is not enclosed in the bag-shaped separator.

In the battery 1b, the dummy electrode plate 17a having the hook portion 17b or the hook portion 17c is enclosed in the bag-shaped second separator 13. However, in the battery 1e, the dummy electrode plate 17a is not enclosed in the bag-shaped separator 13. In the battery 1e, the wall surface resin 12 which is provided in the battery 1 of the first embodiment is not provided. Among the dummy electrode plates 17a having the hook portion 17b or the hook portion 17c, two of the dummy electrode plates 17a, that are very close to the battery case, directly come into contact on the “plane” with the battery case. Here, some the second separators 13, each of that encloses the negative electrode plate 4, work as the wall surface resin 12.

Furthermore, there is the following similarity between the battery 1e and the battery 1b. That is, as in the battery 1a of the second embodiment, the stacked electrode body 6 is interposed between the dummy electrode plate 17a having the hook portion 17b and the dummy electrode plate 17a having the hook portion 17c. The stacked electrode body 6 and the resin plate 11a arranged between the hook portions are supported by the hook portion 17b and the hook portion 17c, the two dummy electrode plates 17a are reliably connected to each other by an insulation tape (not shown) as in the battery 1a of the second embodiment, and the stacked electrode body 6 is fixed between the two dummy electrode plates 17a. Further, as in the battery 1a of the second embodiment, all of the positive electrode tabs 15 and the dummy electrode tabs are connected to the positive electrode terminal 8. Therefore, the dummy electrode plate 17a has a positive electrode potential.

According to this configuration, when the internal temperature of the battery case continuously increases abruptly due to the minute short-circuit as in the battery 1b of the third embodiment, the second separator 13 is melted faster than the first separator 5, and two negative electrode plates 4 at both ends of the stacked electrode body 6 in the Y direction directly come into contact on the “plane” with the dummy electrode plate 17a having a positive electrode potential. Accordingly, it is possible to improve the safety of the battery.

Further, the dummy electrode plate 17a works as an insertion guide when the stacked electrode body 6 is inserted into the container main body 2, and protects the stacked electrode body 6. Therefore, the positive electrode plate 3 or the negative electrode plate 4 is able to be prevented from being bent as in the battery 1b of the third embodiment. Accordingly, because the failure of the battery is able to be further prevented, not only the safety of the battery but also the performance of the battery is able to be further improved.

Further, because the hook portion 17b and the hook portion 17c are pressed to the −Z direction by the weight of the stacked electrode body 6 and directly come into contact with the battery case and because the radiation of heat becomes faster, the battery 1e effectively performs with compared to the battery 1b of the third embodiment. Accordingly, the safety of the battery is able to be further improved.

As described above, because the dummy electrode plate 17a, which is very close to the battery case, directly comes into contact on the “plane” with the battery case, the battery case has a positive electrode potential. Accordingly, as in the battery 1d of the fifth embodiment, the conductive portion 14 does not be needed. That is, because the number of components is able to be reduced with compared to the batteries described in the first to the fourth embodiments, the manufacturing cost is able to be reduced. In a case that the effect is not considered, the dummy electrode plate 17a may be enclosed in the bag-shaped second separator 13 as in the battery 1b of the third embodiment. In this case, the second separator 13 also works as the wall surface resin 12.

The invention is not limited to the above-described embodiments and the combination thereof, and various modifications thereof may be made without departing from the spirit of the invention. For example, the shape of the battery case is described as a square shape, but may be a cylindrical shape. In the same way, the stacked electrode body 6 may be a stacked electrode body (i.e., a stacking-type stacked electrode body) in which positive electrode plates and negative electrode plates are sequentially stacked with separators or a stacked electrode body (i.e., a winding-type stacked electrode body) in which one positive electrode plate and one negative electrode plate are stacked with one separator interposed between them and in which they are wound. In a case that the stacked electrode body 6 is the stacking-type stacked electrode body, the number of the positive electrode plates 3 and the negative electrode plates 4 may be one or more. That is, the number may be appropriately designed to be a plural number.

Further, in the above-described embodiments, the negative electrode plates 4 are arranged at both ends in the Y direction when the stacked electrode body 6 is seen from the X direction, and the conductive portion 14 is connected between the positive electrode terminal 8 and the cover 7 in order that the battery case has a positive electrode potential. However, according to the material (e.g., an active material, an electrolyte, and the like) of the battery, the positive electrode plates 3 may be arranged at both ends of the stacked electrode body 6 and the conductive portion 14 may be connected between the negative electrode terminal 9 and the cover 7 in order that the battery case has a negative electrode potential.

Furthermore, in the above-described embodiments, the conductive battery case has been described, but the battery case may be formed from an insulating resin such as plastic. Then, in this case, the resin 10 may not be formed.

What is claimed is:

1. A battery comprising:
a stacked electrode body in which a first electrode plate having a potential with a first polarity and a second electrode plate having a potential with a second polarity are stacked through a first separator;
a battery case storing the stacked electrode body in a hermetically sealed state and charged to the potential of the first polarity; and
a wall surface resin arranged between the battery case and the stacked electrode body stored in the battery case,
wherein a second temperature at which the wall surface resin is melted or shrunken to cause disappearance or breakage thereof is lower than a first temperature at which the first separator is melted or shrunken to cause disappearance or breakage thereof, and when the internal temperature of the battery case becomes equal to or higher than the second temperature, the battery case and the second electrode plate come into contact with each other or are electrically short-circuited to each other.

2. The battery according to claim 1,
wherein the wall surface resin is a bag-shaped second separator, and the second electrode plate is enclosed in the bag-shaped second separator.

3. The battery according to claim 1, further comprising:
a first dummy electrode plate having the potential of the first polarity and a second dummy electrode plate having the potential of the first polarity; and
a second separator that is melted or shrunken at the second temperature and that causes disappearance or breakage thereof at the second temperature,
wherein the stacked electrode body is sandwiched between the first dummy electrode plate and the second dummy electrode plate through the second separator and fixed between the first dummy electrode plate and the second dummy electrode plate, and
wherein the first dummy electrode plate or the second dummy electrode plate comes into contact with the second electrode plate, when the internal temperature of the battery case becomes equal to or higher than the second temperature.

4. The battery according to claim 3,
wherein each of the first dummy electrode plate and the second dummy electrode plate includes a hook portion, the hook portion is arranged to be interposed between the stacked electrode body and the battery case, and the hook portion is pressed to the battery case by the weight of the stacked electrode body.

5. The battery according to claim 1,
wherein the first polarity is a positive electrode, the second polarity is a negative electrode, the first electrode plate is a positive electrode plate, and the second electrode plate is a negative electrode plate.

6. The battery according to claim 2,
wherein the first polarity is a positive electrode, the second polarity is a negative electrode, the first electrode plate is a positive electrode plate, and the second electrode plate is a negative electrode plate.

7. The battery according to claim 3,
wherein the first polarity is a positive electrode, the second polarity is a negative electrode, the first electrode plate is a positive electrode plate, and the second electrode plate is a negative electrode plate.

8. The battery according to claim 4,
wherein the first polarity is a positive electrode, the second polarity is a negative electrode, the first electrode plate is a positive electrode plate, and the second electrode plate is a negative electrode plate.

9. The battery according to claim 1,
wherein the first polarity is a negative electrode, the second polarity is a positive electrode, the first electrode plate is a negative electrode plate, and the second electrode plate is a positive electrode plate.

10. The battery according to claim 2,
wherein the first polarity is a negative electrode, the second polarity is a positive electrode, the first electrode plate is a negative electrode plate, and the second electrode plate is a positive electrode plate.

11. The battery according to claim 3,
wherein the first polarity is a negative electrode, the second polarity is a positive electrode, the first electrode plate is a negative electrode plate, and the second electrode plate is a positive electrode plate.

12. The battery according to claim 4,
wherein the first polarity is a negative electrode, the second polarity is a positive electrode, the first electrode plate is a negative electrode plate, and the second electrode plate is a positive electrode plate.

13. A battery comprising:
a stacked electrode body in which a first electrode plate having a potential with a first polarity and a second electrode plate having a potential with a second polarity are stacked through a first separator;
a dummy electrode plate having a potential of a first polarity;
a first wall surface resin that is arranged to be interposed between the second electrode plate and the dummy electrode plate; and
a battery case storing the stacked electrode body, the dummy electrode plate, and the first wall surface resin in a hermetically sealed state,
wherein a second temperature at which the first wall surface resin is melted or shrunken to cause disappearance or breakage thereof is lower than a first temperature at which the first separator is melted or shrunken to cause disappearance or breakage thereof, and
wherein the second electrode plate and the dummy electrode plate come into contact with each other or are electrically short-circuited to each other, when the internal temperature of the battery case becomes equal to or higher than the second temperature.

14. The battery according to claim 13,
wherein the first wall surface resin is a bag-shaped second separator and encloses the dummy electrode plate.

15. The battery according to claim 13, further comprising:
a second wall surface resin that is arranged between the battery case and the stacked electrode body and is melted or shrunken at the second temperature to cause disappearance or breakage thereof,
wherein the battery case and the second electrode plate come into contact with each other or are electrically short-circuited to each other, when the internal temperature of the battery case becomes equal to or higher than the second temperature.

16. The battery according to claim 13,
wherein the first polarity is a positive electrode, the second polarity is a negative electrode, the first electrode plate is a positive electrode plate, and the second electrode plate is a negative electrode plate.

17. The battery according to claim 14,
wherein the first polarity is a positive electrode, the second polarity is a negative electrode, the first electrode plate is a positive electrode plate, and the second electrode plate is a negative electrode plate.

18. The battery according to claim 15,
wherein the first polarity is a positive electrode, the second polarity is a negative electrode, the first electrode plate is a positive electrode plate, and the second electrode plate is a negative electrode plate.
